(19) United States
(12) Patent Application Publication
(10) Pub. No.: US 2005/0242178 A1
(43) Pub. Date: Nov. 3, 2005

(54) Printing system, POS system, connection device, and control method and control program for printing system

(76) Inventor: Masahiro Minowa, Nagano-Ken (JP)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/102,049

(22) Filed: Apr. 8, 2005

(30) Foreign Application Priority Data
Apr. 8, 2004 (JP) 2004-114279
Apr. 8, 2004 (JP) 2004-114280

(51) Int. Cl. G07G 1/12; B41J 29/40

(52) U.S. Cl. 235/383; 705/14

(57) ABSTRACT

Advertising or sales promotion information can be additionally printed on a sales receipt without changing the POS application of the POS system, which includes a terminal computer for generating first print (e.g., sales) data based on transaction information, a server for generating second print data comprising advertising or sales promotion information, and a printer in which an interface device for communication with the terminal computer and the server is installed. The interface device has a first print data processing unit and a second print data processing unit, the former of which passes the first print data received from the terminal computer to both the printer and server. The server generates the second print data based on the content of the first print data, and then sends the second print data to the interface device, which sends that data to the printer.

### BACKGROUND OF THE INVENTION

1. Field of the Invention

The present invention relates to a printing system having a terminal computer that generates first print data for printing transaction information on a receipt, an information-providing server that generates second print data for printing advertising or sales promotion information on a receipt, and a printing apparatus, in communication with the terminal computer and information-providing server, that prints based on the first print data and second print data. The invention also relates to a POS system, a connection device, and a control method and program for such a printing system.

2. Description of the Related Art

POS terminals that can print advertising or sales promotion information about specially priced items or events on a receipt, in addition to the typical product and price information about the purchased goods, are widely used in POS (point-of-sale) systems commonly deployed in supermarkets, convenience stores, and other retail businesses. Specialized systems for issuing coupons and lottery tickets, instead of only advertising or sales promotion information, have also been introduced. Specially targeted sales promotion information may also be added by these systems, making the printed receipt an effective sales promotion tool.

A conventional POS system as described above typically has a POS server that stores a master set of product information and centrally manages a plurality of POS terminals, and an information-providing server for serving the advertising or sales promotion information. When processing a transaction, the barcode contained on each product purchased by the customer is scanned to capture a product code, which is sent to the POS server. The POS server then retrieves the product data (i.e., the product name and price information) from the master set of product information stored on the server based on the supplied product code. This product data is used to generate the product information to be printed on the receipt. The POS server or POS terminal also sends the product code to the information-providing server, which then extracts and sends the advertising or sales promotion information related to the transaction data (the items to be purchased, for example) back to the POS server or POS terminal. The POS server or POS terminal then generates print data based on this product information and advertising or sales promotion information and sends the resulting print data to a dedicated printing apparatus to issue a ticket or coupon containing advertising or sales promotion information. See, for example, Japanese Published Patent Application 2003-500767A, and in particular FIG. 2 of that application.

In order to add such a function for adding advertising or sales promotion information to an existing POS system that can only print receipts containing product information relating to the purchased products and their prices, and that does not already have a function for adding such advertising or sales promotion information, the POS application or POS terminal must be modified by, for example, providing a connection to the information-providing server and adding a process for sending data input to the POS terminal to the information-providing server. As a result, many retailers are forced to forgo using this extremely effective advertising and sales promotion tool.

### SUMMARY OF THE INVENTION

Accordingly, an object of the present invention is to provide a system arrangement that enables the addition of a function for adding and printing advertising or sales promotion information on a receipt, without requiring modification of either the POS application or POS terminal. The invention may be embodied in a printing system, POS system, connection device, and/or printing system control method/program.

According to one aspect of the invention, a printing system that has a print processing unit is provided. The system further comprises at least one terminal computer, each of which has a first print data generating unit for generating first print data containing sales information related to a particular transaction that is used in creating a receipt for the customer of the transaction. The system also includes an information-providing server that has a second print data generating unit that analyzes the first print data and determines if any advertising or sales promotion information stored in the server is relevant to the sales information of the first print data. Based on this analysis and determination, the second print data generating unit then selectively generates second print data containing relevant advertising or sales promotion information. An interface device communicates with both the terminal computer and the information-providing server. The interface device has a first print data processing unit that sends the first print data received from the terminal computer to the print processing unit and to the information-providing server. A second print data processing unit sends any second print data that is received from the information-providing server to the print processing unit, which prints a receipt containing the sales information of the first print data and, if applicable, relevant advertising or sales promotion information of the second print data.

In another aspect, the invention involves a control method for a printing system that has a first host device for generating first print data, a second host device for performing an analysis on the first print data and for selectively generating second print data based on the analysis, and a printer having an interface device for receiving the first print data and second print data and for printing based on the first print data and second print data. The control method comprises sending the first print data received by the interface device from the first host device to the printer and asserting a first print command, and also sending such first print data to the second host device; analyzing the first print data received by the second host device from the interface device, detecting if any advertising or sales promotion information stored in the second host device is relevant to sales information contained in the first print data, and selectively generating the second print data based the analysis and detection results; sending any generated second print data to the interface device; and sending the second print data, if received by the interface device from the second host device, to the printer and asserting a second print command.

The foregoing printing system and control method enable printing both first print data received from a terminal computer (first host device) and second print data received from an information-providing server (second host device) on a common printer. As a result, the invention advantageously provides a function that automatically searches for and adds relevant advertising or sales promotion information (second print data) to an issued receipt containing sales transaction information, without requiring the modification of the POS application or the terminal computer. The relevant advertising or sales promotion information for a particular product is determined in advance and is linked to that product or product code. Which advertising or sales promotion information is deemed relevant to which product is typically determined according to any marketing strategy that the particular business using the system deems effective. Some products may be linked to multiple advertising or sales promotion information, while others are not linked to any.

In this printing system the interface device preferably generates and sends end status data denoting receipt of an end identification code to the information-providing server, after the end identification code is received from the terminal computer, the end identification code being specific data indicating that transmission of the first data from the terminal data to the interface is coming to an end. Preferably, the information-providing server stops analyzing the first print data when the end status data is received, selectively generates the second print data based on the analyze and determine operations performed on the first print data, and sends the second print data to the interface device.

The control method for this printing system likewise preferably includes steps that carry out these functions, i.e., sending end status data to the second host device in response to receipt by the interface device of an end identification code that is contained in the first print data and indicates that transmission of the first print data from terminal computer is complete or substantially complete; and terminating the analyzing and detecting operations being performed on the first print data when the end status data is received by the second host device, and sending the second print data, if generated, to the interface device.

The data in the last line of the first print data, or data or a command that is always added to the end of the first print data, can be defined as the end identification code denoting the end or near the end of the first print data. The printer detects the end of the sales transaction data being received and based thereon sends end status data denoting the end of the data to be analyzed in the current process to the information-providing server. The server thus efficiently stops analysis of the first print data and quickly generates the second print data.

Preferably, the first print data generating unit of the terminal computer sets a different transaction number for each transaction, and generates the first print data for each transaction with the corresponding transaction number contained therein; the first print data processing unit of the interface device extracts and temporarily stores the transaction number from the first print data, and sends the end status data with the transaction number appended thereto to the information-providing server; and the second print data generating unit of the information-providing server generates the second print data for select advertising or sales promotion information that is determined to be linked to the sales information of the first print data, adds the transaction number to the second print data, and sends the generated second print data to the interface device.

Yet further preferably, the terminal computer of this printing system also has a printer driver for controlling the print processing unit. The printer driver extracts the transaction number from the first print data, generates transaction number data and sends that data appended to the first print data to the interface device. The first print data sent by the interface device to the information-providing server includes the transaction number data added thereto. The second print data generating unit of the information-providing server adds the transaction number data to the second print data, if generated, and sends the resulting second print data to the interface device.

Thus comprised, the information-providing server uses the transaction number to manage data processing, and can thereby reliably and efficiently analyze the first print data and generate relevant second print data. In general, the information-providing server must distribute the correct advertising or sales promotion information to each print processing unit of each printer. As a result, problems arising from erroneously sending the second print data to the wrong printer are avoided by sending second print data containing this transaction number to the interface device.

When the information-providing server is connected to a plurality of terminal computers and printers, the format of the first print data may vary between terminal computers. However, because the interface device or printer driver can be specifically configured for each connected terminal computer, transaction numbers can be extracted from different first print data formats by using a common standard (a transaction number acquisition standard configured to the information-providing server), and the information-providing server can thus extract transaction numbers without considering differences in the format used by each terminal computer.

The information-providing server in this printing system preferably also has a second print data generation history storage medium for storing a record of second print data generated and linking each set to the corresponding transaction number. By doing this, when and where the second print data was printed can be determined and this information can be used to assist in identifying forged coupons or other attempted illegal use of the information.

Yet further preferably, the interface device interprets the first print data received from the terminal computer, temporarily stores a paper cut command that controls the cutting of the trailing end of the receipt when received, sends the first print data to the print processing unit without sending the paper cut command, and sends the stored paper cut command after the second print data to the print processing unit when the second print data is received from the information-providing server.

The printing system control method further preferably includes the steps of the interface device temporarily storing the paper cut command when received from the first host device, and sending the stored paper cut command after the second print data to the printer, if the second print data is received from the second host device. In this arrangement, the interface device temporarily stores the paper cut command and adds the paper cut command to the end of the second print data. As a result, the first print data and second print data can be printed continuously on a receipt, and the trailing end of the receipt can be automatically cut after the second print data is printed, if the printer has an automatic paper cutter.

When the interface device in the foregoing printing system and method detects a paper cut command, the paper cut command is preferably temporarily stored, specific print data is generated, and this specific print data is then sent to the printer and printed. The interface device thus temporarily stores the paper cut command and asserts a print command for specific print data when a paper cut command for cutting the trailing end of the receipt is detected in the first print data. As a result, specific print data can be printed in the waiting period between the end of printing the first print data and the start of printing the second print data.

Yet further preferably in this printing system, the interface device stores or generates divider line print data as the specific print data for printing a divider line, such as a dotted line or double solid lines, widthwise with respect to the receipt. With this feature, the boundary between the first print data and second print data can be clearly indicated even when the first print data and second print data are printed continuously to the same receipt.

Yet further preferably, the terminal computer stores end marker data as last print data for printing near the trailing end of the receipt, and sends the end marker data after the first print data to the interface device. The interface device temporarily stores the paper cut command and end marker data without sending either to the print processing unit when the paper cut command is received. When second print data is received, the second print data processing unit adds the stored end marker data and paper cut command after the second print data, asserts a second print data and end marker data print command, and asserts a paper cut command processing instruction. The end marker data is preferably words or a message clearly indicating the end of the receipt for the operator, such as “thank for visiting our store.” The operator thus knows that the end of the receipt immediately follows this message, and can thus be prevented from mistakenly thinking that printing has ended and tearing off the receipt even though there is additional data to print after printing the transaction information has ended.

If it is determined by the information-providing server that no advertising or sales promotion information is relevant to the sales information of the first print data, the server preferably generates and sends to the interface device non-printing status information indicating that second print data has not been generated. If non-printing status data is received from the information-providing server, the second print data processing unit of the interface device then omits the second print data print command, and asserts the last print data print command and paper cut command processing instruction. When second print data is not supplied from the information-providing server, the end marker data is printed after the first print data. The operator can thus know that the second print data will not be printed, that is, that printing ended after the first print data.

The end marker data is further preferably stored in the interface device instead of the terminal computer. This arrangement enables the interface device to store and add the end marker data, and in so doing, allows the invention to achieve its effects without modifying the terminal computer (POS application or printer driver).

Yet further preferably, the interface device further comprises a mode setting unit for setting an information-providing mode in which both the first print data process and the second print data process are operated, or a non-information-providing mode in which the second print data process is not executed. When the non-information-providing mode is set, the first print data processing unit omits sending the first print data to the information-providing server, and asserts the paper cut command after the first print data print command without storing the paper cut command when a paper cut command is received. By thus providing the interface device with an information-providing mode for running a process to add the second print data and a non-information-providing mode for printing only the first print data without running the process for adding the second print data, this aspect of the invention enables a business to select the desired operating mode. When a business offers an “early-bird special,” for example, special benefits can be provided to customers that come during the designated service time by, for example, enabling the information-providing mode to print advertising or sales promotion information for discount coupons during the designated hours, and then enabling the non-information-providing mode at other times outside the designated hours. Furthermore, because the second print data process is not run when the non-information-providing mode is active, printing a divider line, such as a dotted line or double line across the width of the receipt as the end marker data or specific print data to clearly delineate the end of printing can be omitted, and paper consumption can thus be reduced.

The mode setting unit is preferably a DIP switch disposed in the interface device or a software switch built into the interface. If a DIP switch is used, the mode can be easily changed by physically changing the position of the switch. If a software switch is used, the mode can be changed by sending a mode selection command for changing the mode from the terminal computer. Also, if a software switch is used, the printer driver could also be written to enable selecting the operating mode.

Also, the end identification code is preferably a paper cut command controlling the cutting of the trailing end of the receipt. If the interface device detects a paper cut command while sending the first print data to the information-providing server, the interface device adds and sends the transaction number. The information-providing server recognizes the paper cut command as the end of the first print data, thus stops analyzing the print data, and generates and sends the second print data to the interface device. The second print data processing unit of the interface device then appends and sends the paper cut command after the second print data to the printing apparatus. By thus using the paper cut command as the end identification code, the present invention can be easily achieved by a slight change on the printing apparatus side, and adjusting or modifying the application program run on the terminal computer is not necessary.

The interface device further preferably has two communication ports, one for connection to the terminal computer and the other for connection to the information-providing server. This arrangement enables the interface device to determine whether the received print data is the first print data or second print data based on the communication port through which the data was received.

According to another aspect of the invention, a POS system is provided. Such system includes a printing system configured according to any of the arrangements described above but having a plurality of terminal computers and respectively associated interface devices, and a POS server for centrally managing the plurality of terminal computers.

Without changing or modifying the POS application or the terminal computer, the present invention thus also affords a POS system to which can be added a function for printing advertising or sales promotion information on a receipt on which sale transaction content is printed.

In still another aspect of the invention, an interface (connection) device for interconnecting a printer, a POS terminal computer, and an information-providing server. The interface device receives primarily transaction data from the terminal computer as first print data and forwards the first print data to the information-providing server, receives second print data from the information-providing server and transfers it to the printer, and asserts a print command to print the first print data and second print data.

This aspect of the invention thus enables an existing POS system to print and issue sales receipts containing a variety of other variable information including coupons, special offers, and event announcements by simply modifying the interface device and without requiring any change to the main components of the existing POS system, including the main body of the printer, the terminal computer, or the POS application running on the terminal computer.

A further aspect of the invention is a set of instructions or program for causing a computer or other instruction-executing device to execute the steps of a printing system control method described above to achieve the advantages also described above.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic diagram of a POS system according to a preferred first embodiment of the present invention;

FIG. 2 is an external oblique view of a terminal computer of such a POS system;

FIG. 3 is an external oblique view of an interface device of such a POS system;

FIG. 4 is a functional block diagram of a printer and information-providing server of such a POS system;

FIG. 5 is a control block diagram of the interface device of such a POS system;

FIG. 6 shows a sample receipt with advertising or sales promotion information, generated according to the first embodiment of the invention;

FIG. 7 is a flow chart showing the processing of the first print data and paper cut command in the interface device;

FIG. 8 is a flow chart showing the processing of the end identification code and second print data in the interface device;

FIG. 9 is a flow chart showing the processing of the first print data and second print data in the IP server;

FIG. 10 is a functional block diagram of a printing system according to a second embodiment of the present invention;

FIG. 11 shows a sample of a receipt with advertising or sales promotion information, generating according to the second embodiment of the invention;

FIG. 12 is a flow chart showing the processing of the first print data in the printer driver according to the second embodiment of the invention;

FIG. 13 is a flow chart showing the processing of the first print data paper cut command in the interface device according to the second embodiment of the invention;

FIG. 14 is a flow chart showing the processing of the second print data in the IP server according to the second embodiment of the invention;

FIG. 15 is a flow chart showing the processing of the second print data in the interface device according to the second embodiment of the invention; and

FIG. 16 is a flow chart showing processing of the first print data and paper cut command in the interface device according to the second embodiment of the invention when the interface device is set to the non-information-providing mode.

### DESCRIPTION OF THE PREFERRED EMBODIMENTS

A POS (point-of-sale) system is used by way of example to describe the invention, including its various aspects, i.e., a printing system, a connection (interface) device, and a control method, execution of which can be specified by control program, with reference to the accompanying figures. A POS system according to the invention can be used in a supermarket, convenience store, drug store, or other retail business.

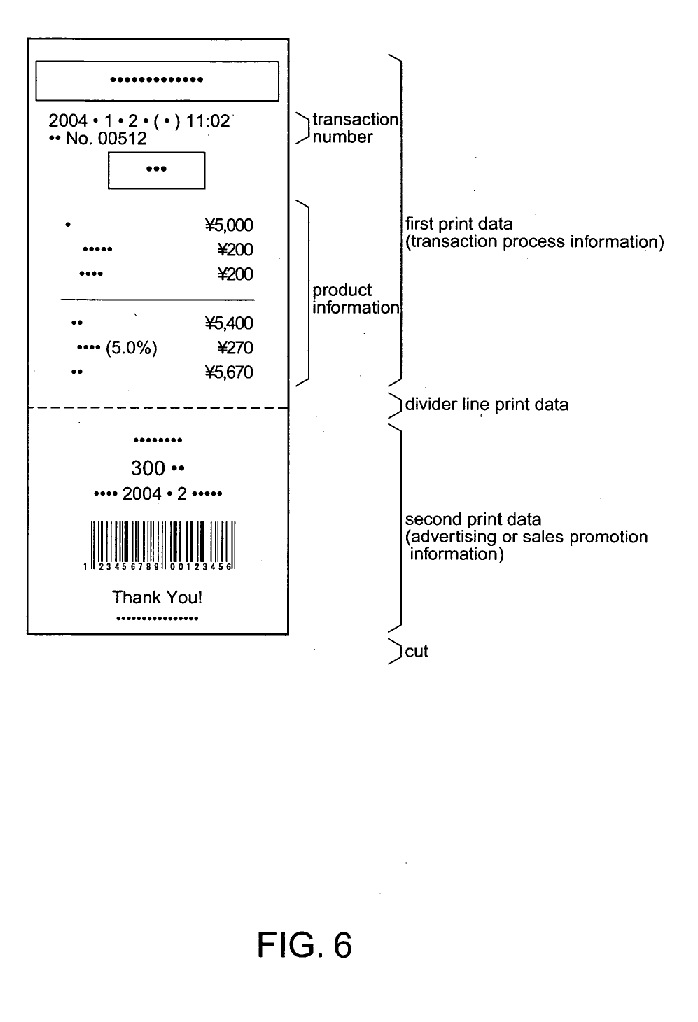

A POS system according to the present invention comprises at least one, but typically more than one, POS terminal, and a POS server for managing the POS terminals. Each POS terminal has a terminal computer for generating first print data containing primarily transaction information to be printed on paper based on input data from the operator, and a printing apparatus (printer) for printing the transaction information (first print data). The present invention enables adding to this POS system the ability to print and issue receipts on which advertising or sales promotion information is also printed (see FIG. 6) without modifying the POS application running on the terminal computer. This is accomplished by employing a connection (interface) device configured according to the invention. The connection device can be installed in an expansion slot of the printer. This connection device enables communication with an information-providing server that provides the advertising or sales promotion information (second print data).

As will be understood, the POS system used to describe the various aspects of the invention contains different components/devices, each of which is connected to, or in communication with, one or more other such components/devices. Accordingly, the terms “connected to,” “in communication with,” and any other similar terms used below include both direct and indirect connections or communications.

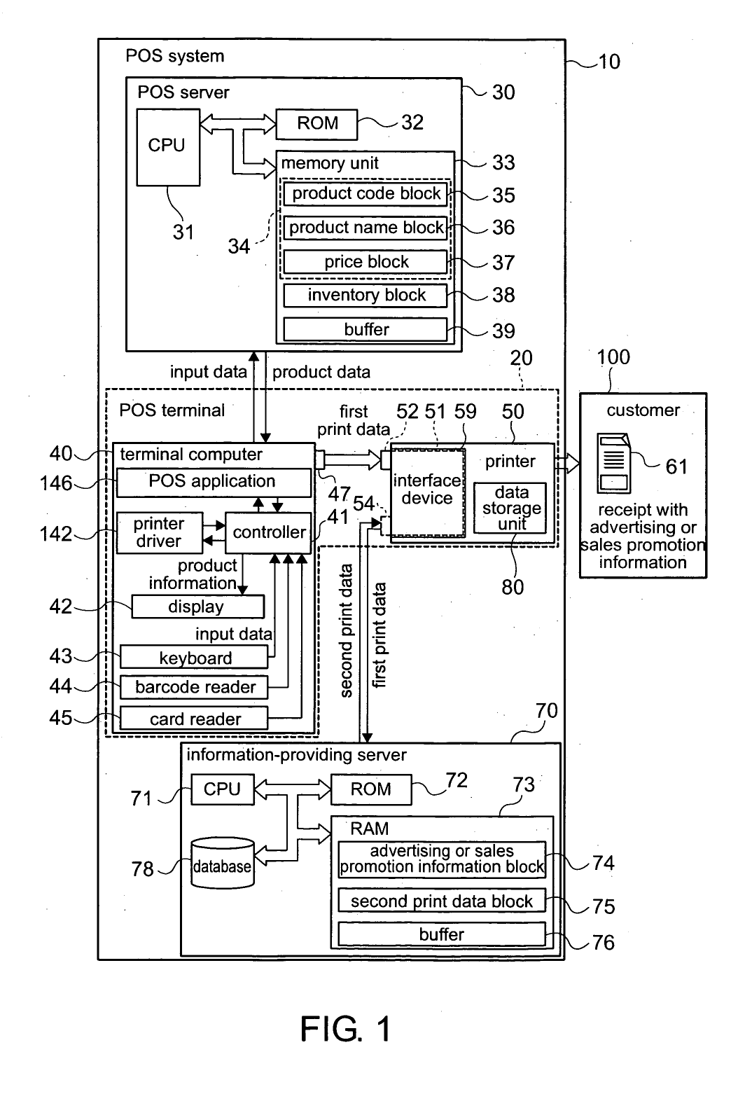

As shown in FIG. 1, a POS system 10 according to the present invention has a plurality of POS terminals 20 (only one of which is shown in FIG. 1), and a POS server 30. Each POS terminal 20 acquires product data (input data) as a result of an operator (user) scanning a barcode printed on or applied to each product. POS server 30 is connected to each POS terminal 20 over a network and manages the input data entered in POS terminals 20.

POS server 30 has a control device (CPU 31), ROM 32, a memory unit 33 that includes RAM, a hard disk drive, or some combination thereof. CPU 31 processes data stored in a buffer 39 in the memory unit 33 according to a control program stored in ROM 32.

Memory unit 33 also includes a product code block 35, product name block 36, price block 37, and an inventory block 38. Based on the input data for products scanned by any POS terminal 20, CPU 31 retrieves information relating to the product code, product name, and price, and generates the product/price data used for printing on a receipt 61 and displaying on a display 42 of POS terminal 20.

This product/price data is the data from which the first print data (transaction information) printed on receipt 61 is generated. The product code block 35, product name block 36, and price block 37 are parts of a lookup table (LUT) 34. Collectively, the information contained in LUT 34 represents a master set of product and price information (master set).

POS terminal 20 has a terminal computer 40 and a printer 50 (receipt printer) which are connected to each other through interfaces 47 and 52. Terminal computer 40 references the master set (in LUT 34) stored on the POS server 30 and thereby acquires product and price data from POS server 30. Printer 50 prints on roll paper based on the first print data and second print data acquired from IP server 70 to be described below.

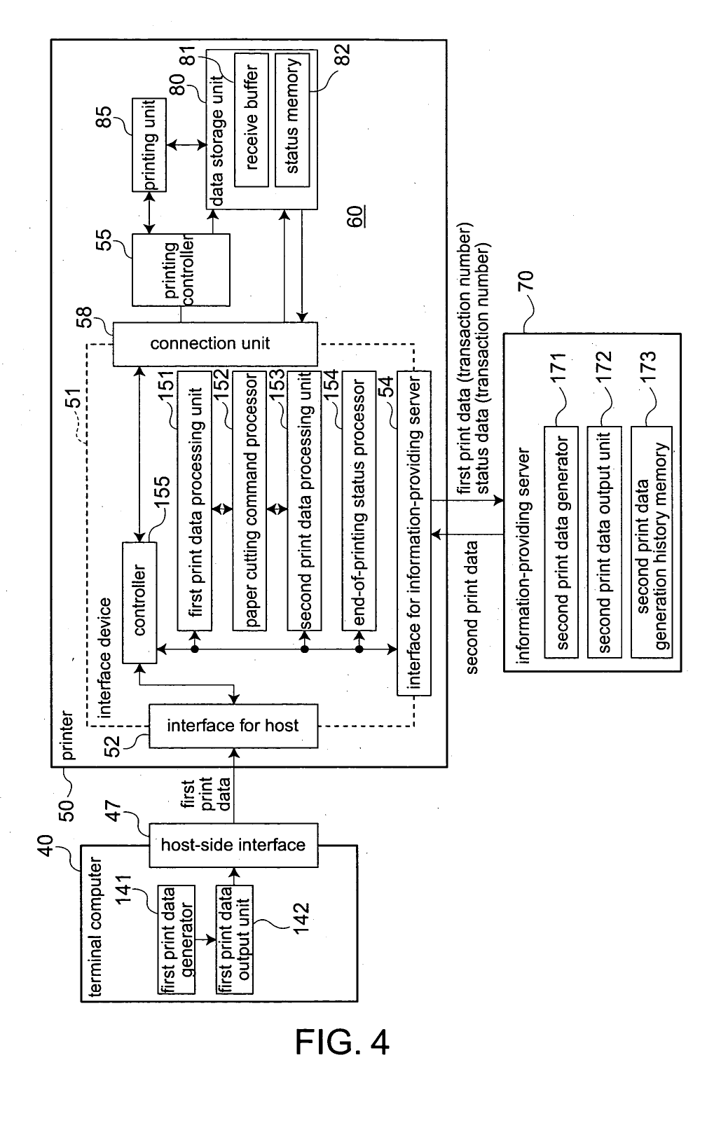

Terminal computer 40 has a POS application 146 for running a transaction process, a printer driver 142 (first print data output unit 142 in FIG. 4) for controlling printing operations of printer 50, and a controller 41 for overall control of the terminal computer.

Controller 41 acquires from POS server 30 data relating to the product code, product name, and price of the products being purchased based on input data acquired from keyboard 43 or a barcode obtained using a barcode reader 44. Controller 41 also acquires information for credit card transactions and input data relating to a member, such as a member number, when the operator reads the credit card or membership card (such as a preferred customer card) of the customer 100 using a card reader 45. Controller 41 also communicates with POS application 146 to set a unique transaction number for each transaction process, and generates transaction process data based on the product data received from POS server 30. Controller 41 also generates first print data including the transaction number information and the transaction process data, and sends the first print data through a printer driver (not shown) to interface device 51. The controller 41 also renders the generated product information on display 42 and displays at least the total amount of the purchase for the operator and customer 100 to see.

Interface device 51 is preferably installed in an expansion slot 59 in printer 50, and can thus be freely inserted in and removed from printer 50. Alternatively, interface device 51 may be a separate component or may be installed in terminal computer 40. In the illustrated embodiment, interface device 51 has a first port providing an interface for connecting terminal computer 40 (referred to as host interface 52 below) and a second port providing an interface for connection to IP server 70 (referred to as IP server interface 54 below). Interface device 51 passes print commands for the first print data received from terminal computer 40 and the second print data received from IP server 70 to a printing process unit 60 of printer 50 (i.e., a printing unit 85, data storage unit 80, and printing controller 55, as shown in FIG. 4). Interface device 51 also monitors the status of the printer and sends status data (e.g., end status data) denoting the second print data transmission timing to IP server 70. Interface device 51 also extracts the transaction number from the first print data received from terminal computer 40, and adds the transaction number in a format enabling the transaction number to be differentiated from the other print data to the first print data, and sends this first print data to IP server 70.

Data storage unit 80 of printer 50 has a receive buffer 81 for temporarily storing print data, and a status memory 82 for storing printer status data. Receive buffer 81 temporarily stores the print data and control commands acquired through interface device 51. Printer 50 runs processes such as the printing process and receipt cutting process based on printing instructions and command processing instructions contained in the print data and control commands, prints the first print data and second print data on paper, and thereby issues a sales receipt 61 also having advertising or sales promotion information.

FIG. 6 shows an example of such a receipt 61 also having advertising or sales promotion information. The first print data, second print data, and divider line data denoting the boundary between the first print data and second print data (such as a dotted line) are printed on receipt 61. As described above, the first print data includes the transaction number and product information (individual product names and prices, and the total purchase amount), and the second print data includes advertising or sales promotion information (such as a human-readable discount coupon and a barcode for scanning by a barcode reader 44 when the advertising or sales promotion information is a discount coupon). Issued receipt 61 is handed by the operator to customer 100. The POS system can thus issue sales receipts, coupons, and provide additional information about up-coming events, for example, on a single receipt.

If printer 50 is an ink-jet printer, for example, capable of monochrome and color printing, the printer can commonly be set to a color printing mode or a monochrome printing mode by means of a DIP switch (not shown) or software switch (not shown) provided for printer 50. In this arrangement, interface device 51 acquires information relating to this mode setting to determine whether color data can be included in the generated print data. A color conversion function could also be rendered in interface device 51 to enable greater printing variety by, for example, converting color print data to monochrome print data if the print data contains color but the printer is set to the monochrome mode, or by conversely converting monochrome print data to color print data if the print data is monochrome but the printer is set to the color mode, thus enabling the store logo, for example, to be printed in a different color than the transaction information.

If printer 50 can print only in monochrome mode or only in a color mode, a function for converting print data to a format compatible with the printer based on printer information acquired by interface device 51 from the printer 50 can also be provided.

Referring to FIG. 1 again, IP server 70 also has memory such as ROM 72 and/or RAM 73, in addition to CPU 71, and further includes a database 78. Data stored in buffer 76 is retrieved for processing by CPU 71 according to a control program stored in ROM 72. Reserved in RAM 73 are an advertising or sales promotion information block 74 for storing the advertising or sales promotion information table referenced to generate the second print data according to the content of the first print data, and a second print data block 75 for temporarily storing the generated second print data.

Based on the first print data received from terminal computer 40 sent to interface device 51, CPU 71 references the advertising or sales promotion information table to generate the second print data, detects the end of one transaction and stops interpreting the received data when the end status data denoting the substantial end of the first print data is received from terminal computer 40 (interface device 51), and based on the interpreted data generates and sends the second print data to interface device 51. CPU 71 also stores a history of generating the second print data in database 78. If the second print data is data for printing a discount coupon, for example, this generation history can be used as a record for verifying that a coupon was not generated illegally, for example.

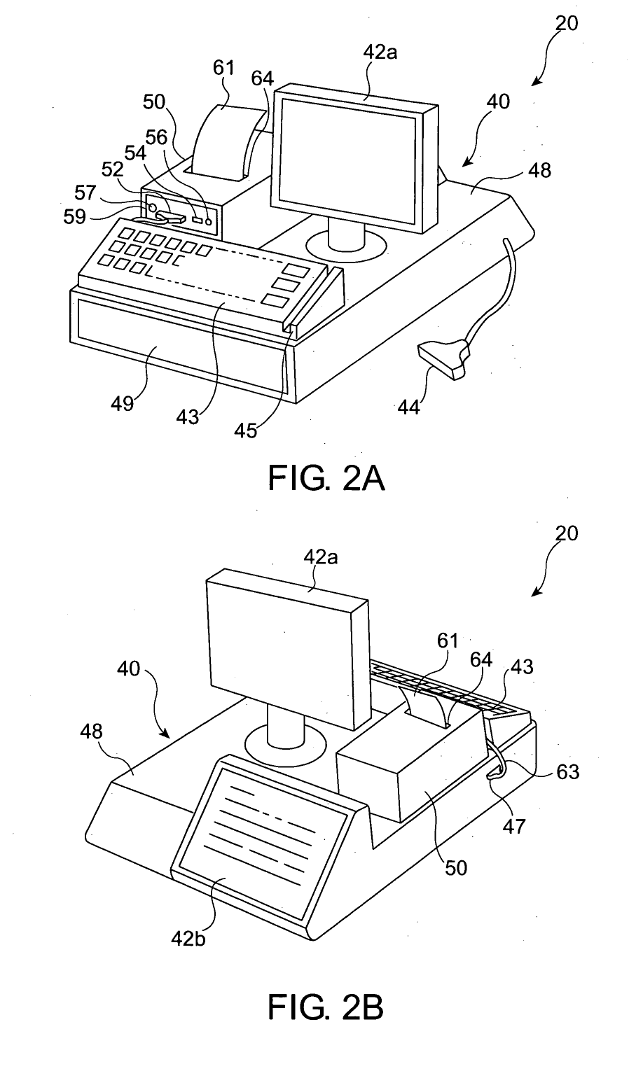

The arrangement of POS terminal 20 is further described below with reference to FIGS. 2A and 2B, the former of which is front oblique view of POS terminal 20 as seen from the operator's side, and the latter of which is a rear oblique view of the POS terminal as seen from the customer's side. These figures show the various components of POS terminal 20 and their structural relationship. In the illustrated configuration, terminal computer 40 includes a box-like main case 48, and printer 50 is disposed to the left rear area of main case 48 and connected thereto by a cable. Of course, the location of printer 50 is not limited to the location shown in FIG. 2; rather, printer 50 can be located anywhere suitable that is within communication distance, e.g. within the length of the cable.

Terminal computer 40 has a keyboard 43 on the operator side of main case 48 to enable the operator to enter input data relating to the products to be purchased, an operator display 42a for displaying the input data for the operator, and a cash drawer 49 housed inside the main case 48. A barcode reader 44 for reading a barcode printed or applied to a product is also connected by cable to the right side of main case 48, and a host-side interface 47 for connection to printer 50 is provided on the left side. A card reader slot 45 for reading a credit card presented by a customer is provided on the side of keyboard 43. A customer display 42b enabling the customer to verify the purchased products and prices, for example, is provided on the customer side of main case 48.

Printer 50, as shown, has interface device 51 installed in an expansion slot 59 (a slot for installing an interface circuit board) at the front of the printer. Interface device 51 and terminal computer 40 are connected through host-side interface 47 and interface for host 52, and interface device 51 and IP server 70 are connected through IP server interface 54 (through a cable not shown). A paper exit 64 from which printed receipt 61 is discharged is formed in the top of printer 50.

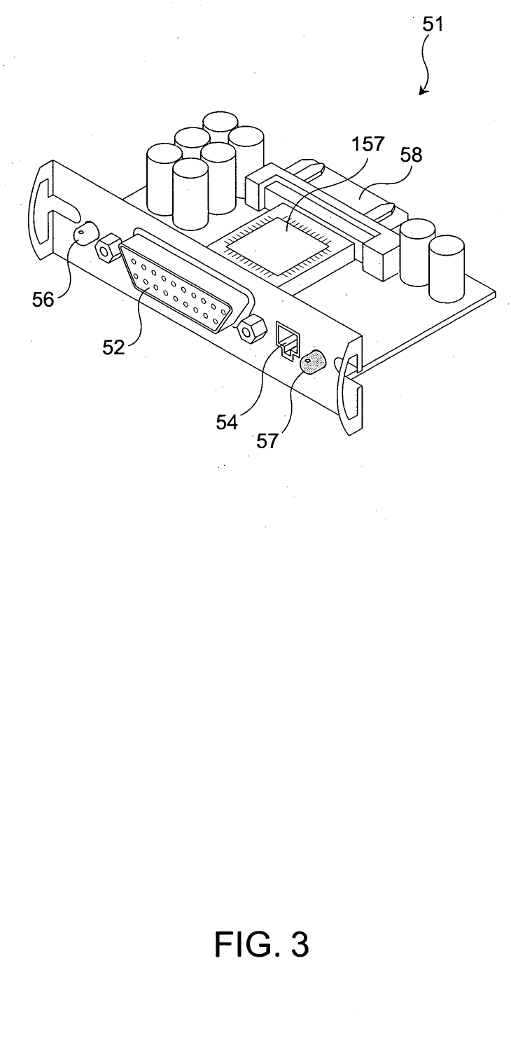

As will be understood from FIG. 3, an operating status indicator 57, host interface 52, IP server interface 54, and printing status indicator 56 for telling the operator whether a printing operation is still in progress are disposed on the front of interface device 51. Interface device 51 is connected to host-side interface 47 of terminal computer 40 by means of a cable 63 (see FIG. 2B). Operating status indicators 57 and 56 are each preferably LEDs that flash or light steady for easy recognition by the operator, but are preferably different colors to prevent misreading by the operator.

Interface device 51 has a control circuit board 157 with ROM 92, RAM 90, or other memory, and other components disposed around a CPU 91. A connection unit 58 (connector) is disposed at the back. Host interface 52, IP server interface 54, connection unit 58, operating status indicator 57, and printing status indicator 56 are connected by a bus 53 to control circuit board 157.

Host interface 52 and IP server interface 54 use a desirable communication protocol enabling, for example, serial data communication based on the RS-232C standard, parallel data communication based on the Centronics standard, a network connection over 10Base-T Ethernet®, or a data communication standard such as USB. Furthermore, the foregoing plural interfaces are not limited to plural physically discrete interfaces. A single physical connector such as an Ethernet connector could be used, for example, with plural logical interface ports managed by interface device 51.

The first print data received from terminal computer 40 can be sent to the IP server 70 by FTP (File Transfer Protocol), UDP (User Datagram Protocol), or other communication protocol. Using FTP over Ethernet offers the advantage of higher reliability than UDP, while UDP offers the advantage of a faster data transfer rate than FTP.

Controlling terminal computer 40, printer 50 (particularly interface device 51), and IP server 70 (that is, the control arrangement of a printing system printing system according to the present invention) is described next with reference to the functional block diagram in FIG. 4. As shown in that figure, the main components of printer 50 are interface device 51 and printing process unit 60, which includes printing controller 55, data storage unit 80, and printing unit 85 having a print head (not shown). Data storage unit 80 includes receive buffer 81 for storing received print data and control commands, and status memory 82 for storing printer status information.

Interface device 51 has a first print data processing unit 151, an end identification code processor 152 (which, in the present embodiment, is represented by paper cutting command processor 152 described below), and a second print data processing unit 153.

First print data processing unit 151 sends first print data received from terminal computer 40 through host-side interface 47 and host interface 52 to printing process unit 60 (more specifically, receive buffer 81) together with a print command, and forwards the first print data to IP server 70. End identification code processor 152 detects the end of the print data for one transaction process (one transaction), and second print data processing unit 153 then sends the second print data received from IP server 70 to printing unit 85.

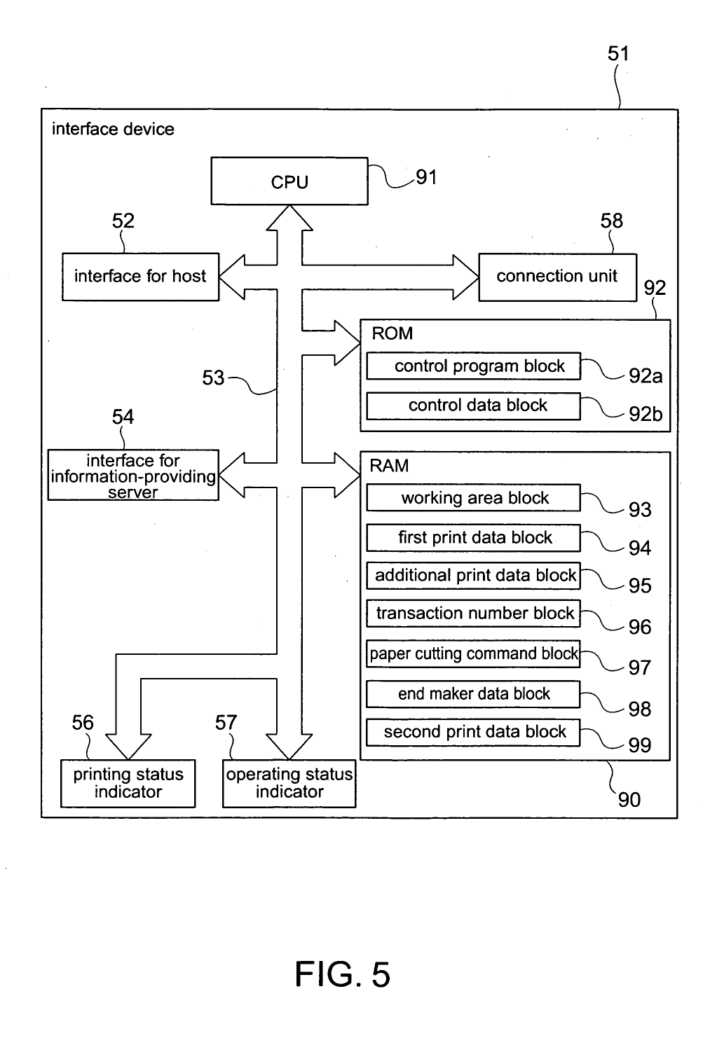

End identification code processor 152 detects the end of the print data, the last line in the print data, or a specific data string near the end of the print data, and generates the end status data. This is achieved in this embodiment of the invention by a paper cutting command processor 152 that detects a paper cut command in the first print data. A specific code denoting the end of printing is required for a printer in which the paper length varies according to the printed content, such as the length of the transaction data printed by a receipt printer, and a paper cut command is generally added to the end of the print data for one transaction when printing a receipt. When paper cutting command processor 152 detects a paper cut command in the first print data, that processor temporarily stores the paper cut command without passing the command to printing process unit 60, generates divider line data (previously stored in ROM 92 (see FIG. 5)), and asserts a divider line data print command.

Second print data processing unit 153 appends the stored paper cut command to the end of the second print data received from IP server 70. When printing process unit 60 completes processing the last line of print data in the first print data, such as converting the data stored in the receive buffer to a data format enabling transmission to the print head, printing process unit 60 sends an end-of-printing status report denoting the substantial end of printing to interface device 51.

In addition to the components noted above, interface device 51 also has an end-of-printing status processor 154 for sending this end-of-printing status to IP server 70, and a controller 155 for controlling the other parts of interface device 51.

When the first print data is received from terminal computer 40, controller 155 passes the first print data to receive buffer 81 by means of first print data processing unit 151, sends a print instruction to printing unit 85, and sends the first print data to IP server 70. The transaction number set by terminal computer 40 is also extracted from the first print data at this time.

If controller 155 detects a paper cut command for automatically cutting across the width of the trailing end of printed receipt 61 in the first print data, paper cutting command processor 152 temporarily stores the paper cut command, generates divider line print data, and sends a print instruction to printing unit 85 to print this divider line.

When controller 155 detects the end-of-printing status data denoting the end of printing at the last line in the first print data from printing process unit 60, end-of-printing status processor 154 adds the transaction number to the end-of-printing status data and then sends the end-of-printing status to IP server 70. Receive buffer 81 in data storage unit 80 is thus nearly empty because the printing process has ended or nearly ended, and IP server 70 can thus determine that the printer is ready to receive the second print data and start to send the data.

When controller 155 receives the second print data from IP server 70, second print data processing unit 153 appends the saved paper cut command after the second print data, and sends a second print data print instruction and paper cut command processing instruction to printing unit 85.

The end or near end of printing can be detected by detecting a data string that is normally used near the last line when printing a receipt. For example, a specific text string that is always printed on a receipt, such as a text string denoting the total amount or sales tax, may not be the last line of print data but still indicates that printing the transaction information is ending. In this situation printing typically ends after printing another one or two lines, and no problems related the transfer time of the following data will occur if such a text string is used to indicate the substantial end of printing. If a text string printed near the last line of print data is defined as the specific data for detecting the end of printing, the second print data can be acquired sooner, and both the first print data and second print data can therefore be printed more quickly.

First print data processing unit 151 adds the transaction number to the end of the first print data regardless of the format of the received first print data. By thus adding the transaction number to a known data position (a position determined by IP server 70 specifications), IP server 70 can easily detect transaction numbers, even when a plurality of POS terminals 20 are connected to the IP server.

The first print data could also be converted to a specific data format according to IP server 70 specifications, and the first print data could be transmitted in a common format. This arrangement enables an IP server 70 connected to a plurality of POS terminals 20 to easily interpret first print data received in a common format, and can thus reduce the processing load on the IP server.

IP server 70 includes a second print data generator 171 that interprets first print data from when it is first received from interface device 51 until the end status data is received, and generates the second print data; a second print data output unit 172 that sends the second print data to interface device 51 when triggered by receiving the end status data from the interface device; and a second print data generation history memory 173 that stores the second print data generation history linked to the transaction number.

When IP server 70 receives the first print data from interface device 51, second print data generator 171 generates the second print data by referencing the advertising or sales promotion information table (in, e.g., advertising or sales promotion information block 74 of FIG. 1). More specifically, the second print data is generated by extracting all advertising or sales promotion information linked to the product codes in the first print data from the advertising or sales promotion information table, which stores the product codes (or product names) contained in the first print data linked to particular advertising or sales promotion information (or advertising/promotional information code) for generating the second print data, and merging (arraying) the extracted advertising or sales promotion information in the order extracted from the table.

If advertising or sales promotion information keyed to a product code contained in the first print data is not found in the table, the second print data is not generated, and status data (no_data status) indicating there is no second print data is sent to interface device 51.

In addition, second print data generator 171 also extracts the transaction number added to the first print data and adds this transaction number to the second print data. Once the second print data is ready, second print data generation history memory 173 stores the generation history keyed to the transaction number.

When IP server 70 receives the end status data with an appended transaction number from interface device 51, IP server 70 recognizes the end status data as the end of the data to be interpreted, therefore stops interpreting the received data, and generates the second print data based on the interpreted data. A transaction number matching the transaction number added to the end status data will obviously preferably be added to the second print data.

The control configuration of interface device 51 is described next with reference to the control block diagram shown in FIG. 5. As shown in that figure, interface device 51 has interface 52 for the host (terminal computer), interface 54 for the IP server, and printer connection unit 58, as well as an operating status indicator 57, CPU 91, ROM 92, and RAM 90 interconnected by an internal bus 53.

Operating status indicator 57 is preferably an LED that lights steady when interface device 51 is executing a process, and flashes when an error occurs in the interface device.

Printing status indicator 56 is also preferably an LED, but emits a different color than operating status indicator 57. Printing status indicator 56 lights steady while interface device 51 is executing a process, including while waiting to receive the second print data, and more specifically lights steady from when interface device 51 starts receiving (or sending) the first print data from controller 41 until the paper cut command is appended to the second print data received from IP server 70 and processing ends.

ROM 92 has a control program block 92a for storing the control program run by the CPU 91, and a control data block 92b for storing control data, including various tables, as well as divider line data generated when a paper cut command is detected.

RAM 90 is used as a working memory for control processes, and includes a working area block 93 used for storing flags, statuses and other data, a first print data block 94 for storing the first print data received from the terminal computer 40, an additional print data block 95 for storing additional print data in the first print data, a transaction number block 96 for storing the transaction number extracted from the first print data, a paper cutting command block 97 for temporarily storing a paper cut command extracted from the first print data, an end marker data block 98 for storing the end marker data indicative of the substantially last line of the print data received from the terminal computer 40, and a second print data block 99 for storing the second print data received from IP server 70.

The first print data, end marker data (included in the first print data), second print data, and other input data are received over internal bus 53 from host interface 52, IP server interface 54, and printer connection unit 58. Data and control signals from CPU 91 are similarly output over bus 53 to their destinations: terminal computer 40, IP server 70, and/or printing unit 85 (see FIG. 4) through the interfaces 52, 54 and 58, respectively.

Based on a control program stored in ROM 92, CPU 91 thus handles print data communication (sending and receiving), processing paper cut commands, and controlling interface device 51 by receiving input signals and data, processing data in RAM 90, and outputting signals and data.

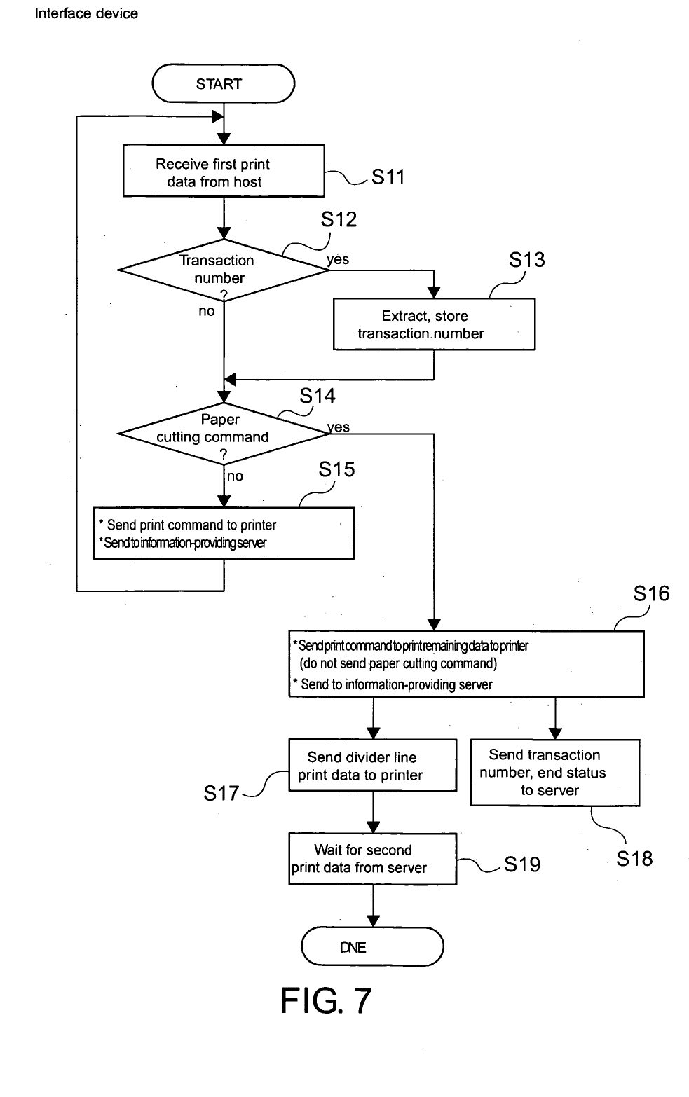

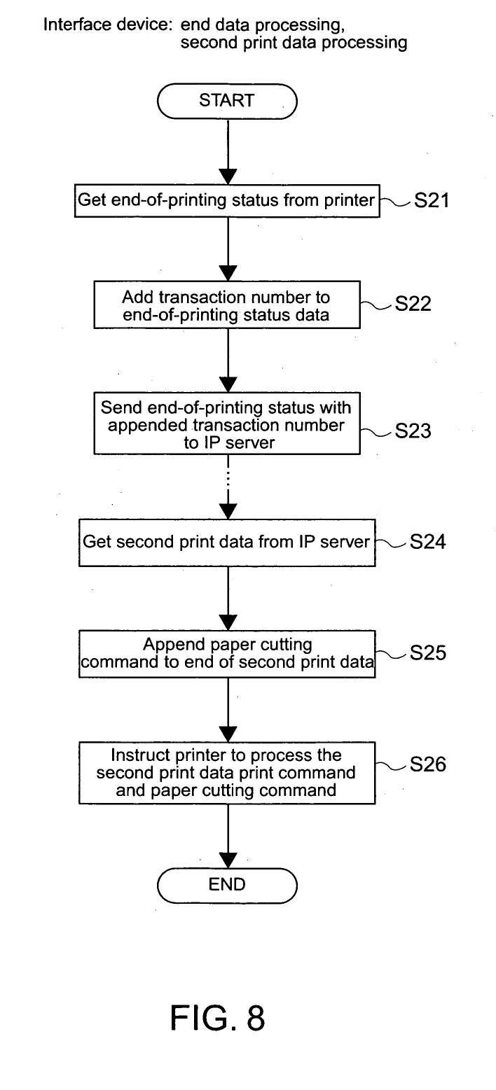

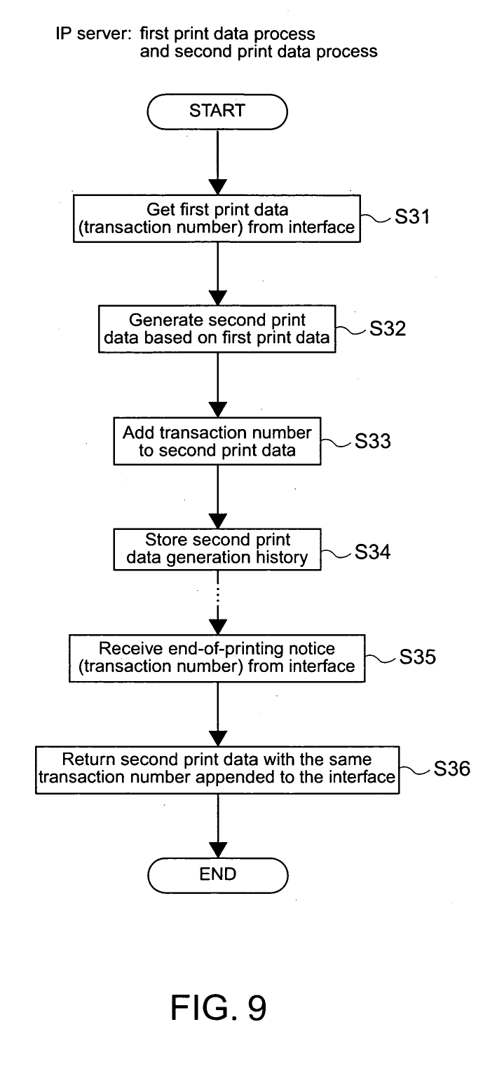

The printing control method of the present invention is described next below with reference to the flow charts in FIG. 7 to FIG. 9. FIG. 7 shows the processing of the first print data and paper cut command by interface device 51, FIG. 8 shows the operations from the processing of the end identification code to the processing of the second print data by interface device 51, and FIG. 9 shows the operations from the processing of the first print data to the processing of the second print data by IP server 70.

Referring first to FIG. 7, when interface device 51 receives the first print data from terminal computer 40 (S11), the interface device sends a print instruction to printing unit 85 at the end of each line of data in the print data, and passes the first print data to IP server 70 with the print instruction sent to printing unit 85 (S15). Data denoting the transaction number is contained in the first print data as described above. Therefore, when this transaction number is received (detected), the transaction number is extracted (S13) and written to the transaction number block 96 (see FIG. 5).

When a paper cut command is detected in the received print data (generally at the end of the print data) (S14), the paper cut command is saved in paper cut command block 97 (see FIG. 5) (S16) and a divider line print command is sent to printing unit 85 instead of the paper cut command (S17). After all of the first print data has been received, the transaction number is then appended to the end of the first print data (S18). The transaction number is thus appended to the end of the first print data sent to IP server 70 in step S12. After the divider line print command is executed the interface device waits to receive the second print data (S19). The saved paper cut command is later appended to the end of the second print data received from IP server 70 (see step S25, FIG. 8).

While the first print data received from terminal computer 40 is usually sent line-by-line together with a print command to the printer, the invention is not limited to that mode of transfer. For example, interface device 51 could send the print data with a print command after all of the first print data is received. More specifically, steps S13 to S15 follow step S11, the print command and data are then sent in step S12, and the divider line print command is then sent in S16.

To enable extracting the transaction number or interpreting the print data by the IP server, the data sent from the terminal computer must be in text, XML, or other format enabling the print data content to be interpreted.

The operation of interface device 51 from processing the end-of-printing status to processing the second print data is described next with reference to FIG. 8. When the interface device 51 receives the end-of-printing status indicating the end of processing the print data (first print data) at or near the last line of print data (S21), the interface device appends the transaction number stored in transaction number block 96 to the end-of-printing status data (S22), and sends an end-of-printing report containing the transaction number to IP server 70 (S23).

When IP server 70 then sends the second print data in response to this end-of-printing report, interface device 51 receives the second print data (S24) and appends the paper cut command stored in paper cut command block 97 to the end of the second print data (S25). Interface device 51 then applies a second print data print command and paper cut command processing command to printing unit 85 (S26).

By thus adding the paper cut command to the end of the second print data, the second print data is printed on receipt 61 as shown in FIG. 6, the paper cutter of the printer thus cuts the trailing end of the receipt after the second print data, and the receipt on which the first print data and second print data are consecutively printed is issued without cutting the paper between the first print data and the second print data. If the printer does not have an automatic paper cutter, the receipt waits to be manually cut by the operator.

A divider line is also printed between the first and second print data when a paper cut command is received in the first print data because a divider line print command is substituted for the paper cut command (S16, FIG. 7). The boundary between the first print data and second print data is thus clearly delineated, the customer can use this divider line to know where to cut the receipt from any coupon following in the second print data, and coupons and the like can be compactly stored.

If second print data is not received from IP server 70 (that is, when the no_data status indicating that second print data was not sent from IP server 70 is received because none of the product codes in the first print data is found in the advertising or sales promotion information table), receipt 61 will be cut immediately after the divider line. The divider line data could, of course, be omitted in this case.

The operation of IP server 70 from processing the first print data to processing the second print data is described next with reference to FIG. 9. When first print data containing a transaction number is received from interface device 51 (S31), IP server 70 references the advertising or sales promotion information table and generates second print data relating to the products contained in the first print data (S32). The transaction number extracted from the first print data is then added to this second print data, and the second print data and transaction number are stored in buffer 76 (see FIG. 1). This second print data is also stored in database 78 and keyed to the transaction number (S34).

Note that the transaction number and the advertising or sales promotion information codes identifying the content of the second print data (the advertising or sales promotion information) can be stored in database 78 instead of storing the second print data itself. The store, date, and time that the receipt is issued, a second print data creation number, an ID code for POS terminal 20 and operator, and the product codes can additionally be stored.

If a coupon is issued or used improperly, storing the second print data generation history linked to the specific transaction number as described above enables retrieving the information printed on the coupon and the other information linked to the coupon to reference the store and date that the coupon was issued, for example, thereby helping to prevent unauthorized use.

If an end-of-printing report with an attached transaction number is received from interface device 51 (S35), buffer 76 is searched for second print data containing the same transaction number, and the located second print data is sent to interface device 51 (S36). The transaction number can be omitted from this transmission if desired.

As described above, this embodiment of the invention thus sends an end-of-printing report to IP server 70 to trigger transmission of the second print data when printing unit 85 finishes processing the last line of print data. Printer 50 can thus acquire the second print data when there is no unprocessed print data remaining in data storage unit 80, which is thus prevented from overflowing. Consequently, both the first print data and second print data can be reliably printed.

Furthermore, interface device 51 will not mistakenly send the second print data to the wrong printer in the situation in which IP server 70 is connected to a plurality of terminal computers 40 and printers 50, because the interface device adds and sends a transaction number with the end-of-printing report to IP server 70 when processing the last line of print data ends, and IP server 70 thus returns second print data containing a transaction number matching the received transaction number to the interface device 51.

Thus, when IP server 70 is connected to a plurality of terminal computers 40 and printers 50, the IP server must generate the second print data based on the first print data received from a particular one of the plural terminal computers, and must return the second print data to the printer of the terminal computer that sent the first print data. The first print data is normally sent with an identifier (printer identification command) identifying the printer corresponding to the particular terminal computer sending the first print data, but if data is successively sent from the same terminal computer, the second print data must be generated while simultaneously interpreting first print data containing the same identifier. As a result, the second print data could be output at the wrong timing, and the wrong advertising or sales promotion information could be printed.

The present invention avoids this problem by adding a different, unique transaction number (these transaction numbers are also unique even when multiple terminal computers 40 are connected to the same IP server) for each transaction process to the end-of-printing report sent to the IP server to trigger sending the second print data, and tprinter 50 can thus acquire the correct advertising or sales promotion information at the appropriate timing.

Furthermore, conventional POS systems generally already generate a unique transaction number when producing print data for a transaction process. By using this same transaction number, the processing load on the terminal computer can be reduced and there is no need to add a new process or function for generating transaction numbers to the terminal computer.

The transaction number extraction process can also be omitted from IP server 70 because interface device 51 extracts the transaction number from the first print data (see S13, FIG. 7). Moreover, when IP server 70 is connected to a plurality of terminal computers 40 and printers 50, the first print data format could differ depending upon the characteristics of terminal computer 40. However, by configuring interface device 51 for the terminal computer to which the interface device is connected, transaction numbers can be extracted from first print data in different formats using a common standard (the transaction number acquisition standard of IP server 70). As a result, IP server 70 can acquire transaction numbers without considering differences in the data formats used by different terminal computers 40.

Interface device 51 sends an end-of-printing report to IP server 70 when the printing process is completed for the last line in the foregoing embodiment, but the invention is not limited to that processing procedure. Instead, the end-of-printing report could be output when the printing process is completed for, say, the second to last line. In general, the specific data determining the timing at which the end-of-printing report is output in this situation is preferably set to data at or near the last data. If, for example, this specific data is the print data for the second to last line, interface device 51 outputs the end-of-printing report to IP server 70 when processing this second to last line of print data ends.

Whatever the last line or a different line close to the last line corresponds to the specific data above, receiving this end-of-printing report then triggers IP server 70 to send the second print data to interface device 51. Printer 50 can thus acquire the second print data while the last line of print data remains in data storage unit 80. It will thus be apparent that using data as close as possible to the last print data as the specific trigger data more reliably prevents a buffer overflow from data storage unit 80 and thus more reliably assures that both first and second print data can be printed.

Depending upon the capacity of the receive buffer, however, any specific data that precedes the last data but consistently indicates the approaching end of the receipt, such as a specific text string (such as “total” or “sales tax”) that is printed on every receipt, can be used as this specific data. This arrangement enables the second print data to be acquired at an earlier time and thus enables printing both first and second print data more quickly. The timing at which the end-of-printing report is output can thus be desirably set based on throughput.

The paper cut command is also temporarily stored when a paper cut command is detected (S15 in FIG. 7), but this step can be omitted. The paper cut command can also be used as the end identification code (i.e., interface device 51 is configured to send the end-of-printing report to IP server 70 when processing the paper cut command ends). In this case the first print data and second print data are printed on physically separate receipts 61. In this situation IP server 70 or interface device 51 preferably adds a paper cut command after the second print data. This enables issuing a receipt 61 that is automatically cut at the trailing end after printing the second print data ends.

The transaction number is not added to the second print data sent by IP server 70 to interface device 51 in the above embodiment, but IP server 70 could add the transaction number to the second print data. As described above, a transaction number unique to each transaction process is added to the end status data sent by interface device 51 to IP server 70, and the IP server returns second print data corresponding to the received transaction number to interface device 51. Sending the wrong second print data is thus unlikely, but even if an error or a trouble occurs on the POS terminal, the unique number can facilitate matching of the each data in the POS system. When the transaction number is printed on each of a receipt and a material for additional information corresponding to the receipt, it is possible to confirm the matching between them even if the printed materials are separated.

If the transaction numbers do not match, interface device 51 preferably sends status data (a cannot_receive error) indicating that the received second print data cannot be received to IP server 70. In this situation IP server 70 searches whether the same transaction number is found in other second print data that is still unsent and sends that second print data, if found, thereby enabling interface device 51 to acquire the correct second print data. If the transaction number is not found, an error likely occurred. A no_data status is therefore sent to interface device 51, causing operating status indicator 57 of interface device 51 to flash and thus prompting the operator to resend the first print data from terminal computer 40.

Interface device 51 extracts the transaction number in the above-described embodiment (S13 in FIG. 7), but printer driver 142 of the terminal computer 40 (see FIG. 1) could perform this function. In this case the transaction number extraction process is eliminated as a function of interface device 51, and the printer driver for the terminal computer in which it is used is configured to perform this function. IP server 70 can therefore still acquire the transaction numbers without considering differences in the data formats used by different terminal computers 40. Printer driver 142 can also set the transaction numbers, instead of the POS application 146, which performs this function in the foregoing embodiment.

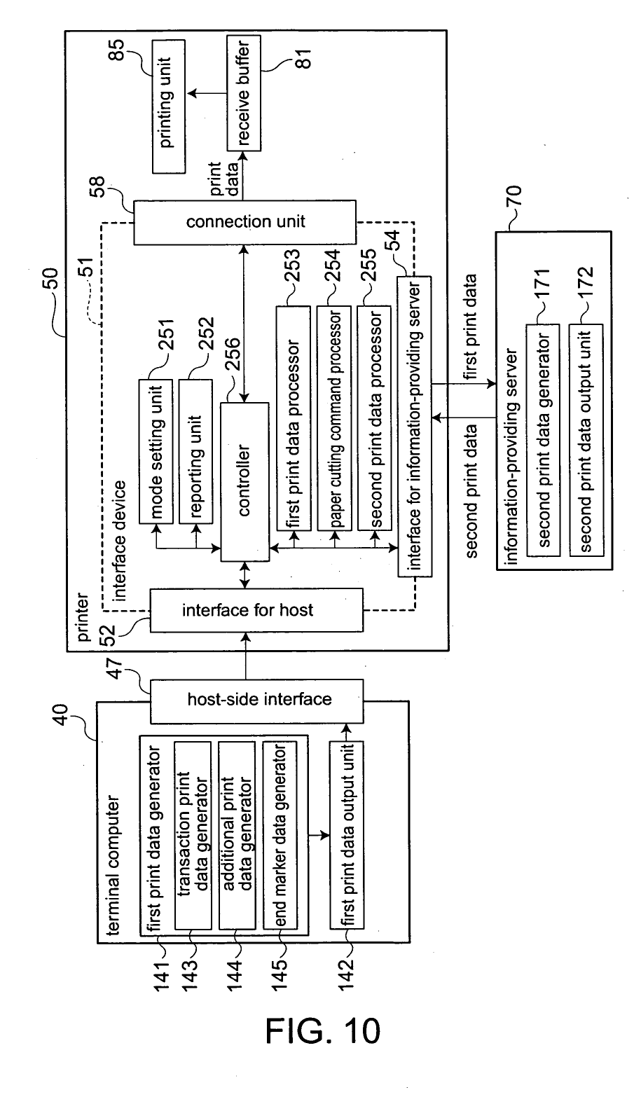

A second embodiment of the present invention is described next below with reference to FIGS. 10-16.

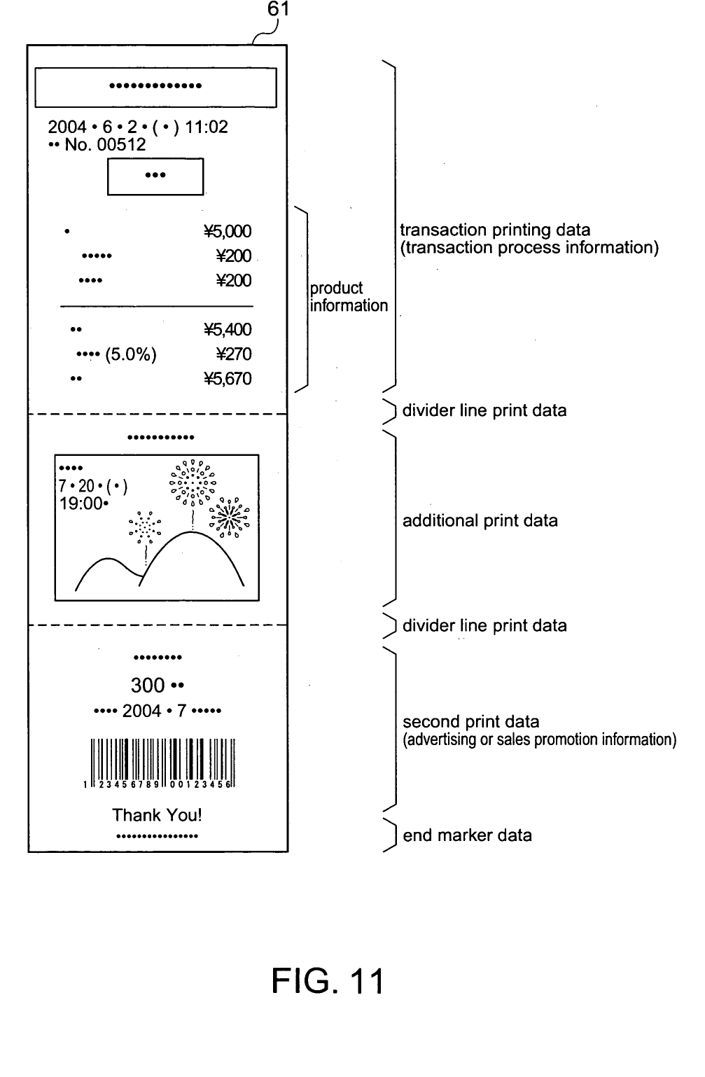

In this embodiment, additional print data and end marker data (see FIG. 11) are received in addition to the first print data from the terminal computer 40, and the print command is asserted based on this print data and the second print data received from IP server 70. The additional print data is printed in the waiting time between the completion of printing the first print data and the start of printing the second print data. As a result, the waiting time can be used effectively. Problems resulting from the operator mistakenly thinking that printing has ended and tearing off the receipt when printing the first print data ends can thus be avoided.

This second embodiment of the invention is described below focusing on the differences from the first embodiment. Note that sending the end status data from interface device 51 to IP server 70 is not described below to simplify the following description of the second embodiment.

As shown in FIG. 11, in this embodiment of the invention, a receipt 61 on which advertising or sales promotion information is also printed contains first print data containing specific information such as product information and a transaction number, additional print data printed after the first print data and including event information or sale information issued by the store, second print data for the advertising or sales promotion information acquired from IP server 70, end marker data such as a message or image indicating the end of the printing process for one transaction process, and divider line print data denoting the boundary between the first print data and additional print data or the boundary between the additional print data and second print data.

The control configuration of a printing system in this embodiment of the invention is described next with reference to the functional block diagram shown in FIG. 10, which shows a terminal computer 40 having a first print data generator 141 for generating first print data of primarily product information, and a first print data output unit 142. First print data generator 141 has a transaction print data generator 143 for generating print data for a transaction process based on the transaction information, an additional print data generator 144 for generating print data for the foregoing additional information, and an end marker data generator 145 for generating end marker data. While some functions of first print data generator 141 can be rendered with POS application 146, i.e., the functions of transaction print data generator 143, the functions of additional print data generator 144 and end marker data generator 145, can be rendered in printer driver 142.

The additional print data and end marker data can be text data representing a specific phrase, data denoting a specific mark or symbol, or even image data denoting a specific picture or logo, for example.

The transaction printing data, additional print data, and marker print data are sent to interface device 51 together with a specific identifier indicating the beginning of the data.

Interface device 51 has a mode setting unit 251 and a reporting unit 252. Mode setting unit 251 enables selecting an information-providing mode in which second print data is provided, or a non-information-providing mode in which the second print data is not provided. Mode setting unit 251 is preferably a DIP switch or software switch. When the non-information-providing mode is set, interface device 51 does not send the first print data received from terminal computer 40 to IP server 70. Furthermore, because the second print data printing process does not run when the non-information-providing mode is set, printing a divider line before the second print data is not necessary, and the divider line print data is therefore also not generated.

Reporting unit 252 is composed of LEDs, i.e., operating status indicator 57) and printing status indicator 56. LED 56 indicates from which interface data is being received, for example, and LED 57 indicates that printing is in progress. Therefore, if reporting unit 252 is located where it is visible to the operator, the operator can easily know if data is being received, and this can be helpful when issuing a receipt.

Interface device 51 also has a first print data processor 253, a paper cut command processor 254, a second print data processor 255, and a controller 256 that controls these other components.

When the first print data (including additional print data and end marker data) is received from terminal computer 40, first print data processor 253 sends the first print data but not including the additional print data and end marker data (that is, sends the transaction printing data) to printing unit 85 with a print command for printing, and also forwards this first print data to IP server 70. Note, however, that the first print data is sent to IP server 70 only when the information-providing mode is active. Furthermore, unless otherwise stated below, the process described below assumes that the information-providing mode is set and active.

Paper cut command processor 254 temporarily stores the paper cut command when a paper cut command is received in the first print data, and outputs a print command for the divider line print data and additional print data.

Second print data processor 255 adds the end marker data and paper cut command after the second print data when second print data is received from IP server 70, and asserts print and process commands.

Thus comprised, when first print data to which additional print data and end marker data is added is received from terminal computer 40, controller 256 controls first print data processor 253 to send the first print data but not the additional print data and end marker data for printing by printing unit 85, and send the first print data not including the additional print data and end marker data to IP server 70. If the non-information-providing mode is set, first print data processor 253 does not send the first print data to IP server 70.

When controller 256 detects a paper cut command inserted to the first print data as the normal termination data, controller 256 controls paper cut command processor 254 to temporarily store and not output the paper cut command to the printer. The end marker data is also stored with the paper cut command. Pre-stored divider line print data is then inserted before the additional print data, and the divider line print data and additional print data are printed. Note that if a paper cut command is detected when the non-information-providing mode is active, controller 256 controls paper cut command processor 254 to temporarily store the paper cut command, adds the paper cut command after the divider line print data and additional print data, and outputs commands to print the data and process the paper cut command. Divider line print data can also be inserted between the additional print data and second print data to print a divider line so that the printed output is easier to read.

When second print data is received from IP server 70, controller 256 controls second print data processor 255 to add the saved end marker data after the second print data, then append the saved paper cut command after the end marker data, and issue printing and processing commands.

Note that the second print data print command is omitted if a no_data status signal indicating that second print data is not sent from IP server 70 is received, and only the end marker data is printed and the paper cut command is processed.

If a paper cut command is detected from the first print data, IP server 70 stops interpreting the first print data, generates the second print data based on the interpreted data, and sends the resulting second print data to interface device 51. By waiting to receive the end status data sent from interface device 51 before starting to send the second print data to the interface device, and sending the second print data starts after IP server 70 knows that the interface device is ready to receive data, the data can be transmitted more reliably.

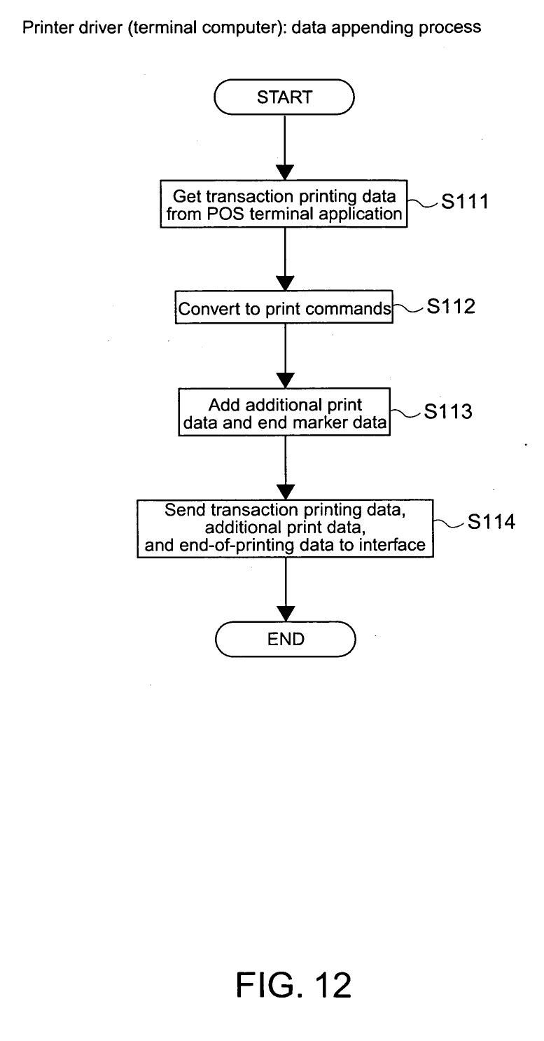

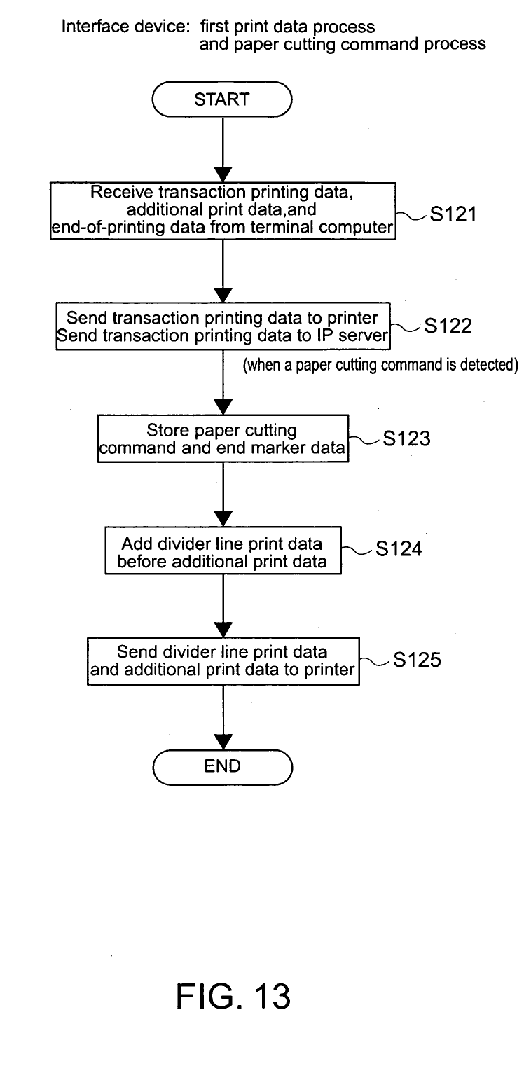

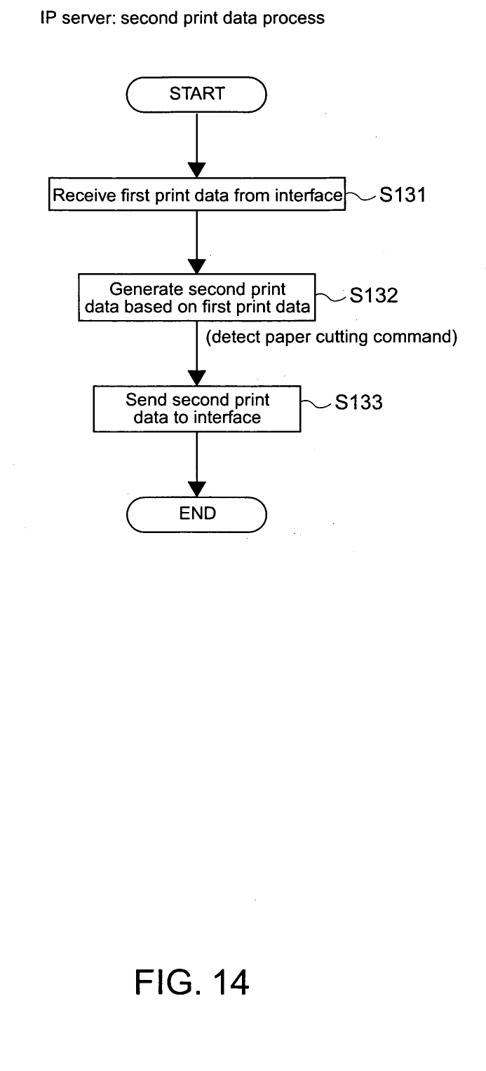

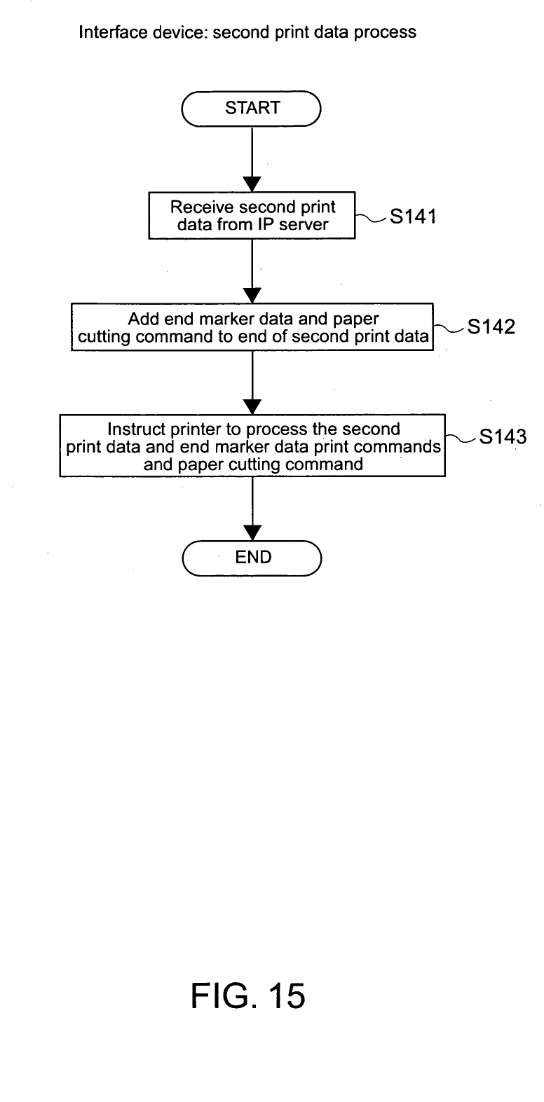

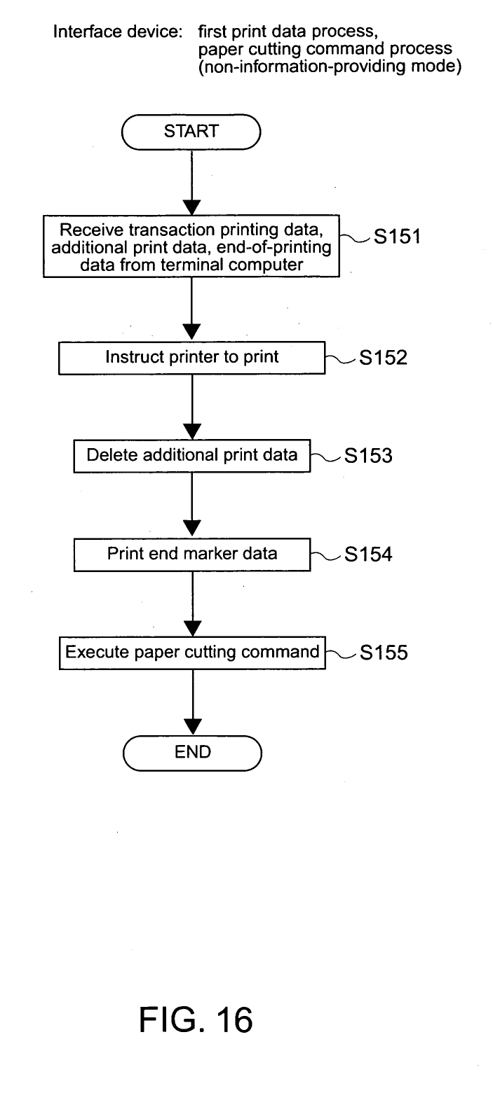

The printing control method in this second embodiment of the invention is described next with reference to the flow charts in FIGS. 12-16. FIG. 12-FIG. 15 show the printing control method when interface device 51 is set to the information-providing mode. More specifically, FIG. 12 shows the data adding process of printer driver 142, FIG. 13 shows processing the first print data and paper cut command by interface device 51, FIG. 14 shows processing the second print data by IP server 70, and FIG. 15 shows processing the second print data by interface device 51. FIG. 16 shows the printing control method when the non-information-providing mode is set.

As shown in FIG. 12, printer driver 142 in terminal computer 40 converts transaction printing data acquired from POS application 146 (S111) to specific printer commands for printer 50 (S112), and appends the specific additional print data and end marker data to the transaction printing data (S113). An identifier is inserted at the beginning of the additional print data and at the beginning of the end marker data so that interface device 51 can use these identifiers to detect the additional print data and end marker data. As a result, the order of the additional print data and end marker data can be reversed as desired. After the additional print data and end marker data is added to the transaction printing data, printer driver 142 outputs the result as the first print data to interface device 51 (S114).

First print data output unit 142 generates the additional print data based on data read from memory. The additional print data can thus be varied according to the time or even customer. The additional print data and end marker data to be printed could be selectively set by, for example, storing multiple additional print data files and multiple end marker data files in memory, and enabling the operator to select the desired data from a printer driver configuration screen presented on operator display 42a. The content of the additional print data can thus be varied, for example, according to the needs of the store, and the printed output can thus be more effectively used as an advertising medium.

Processing the first print data and paper cut command by interface device 51 is described next with reference to FIG. 13. When interface device 51 receives the first print data including additional print data and end marker data from terminal computer 40 (S121), the interface device sends a predetermined line of the first print data excluding the additional print data and end marker data to IP server 70 and to printing unit 85 with a print instruction (S122).

When the additional print data and end marker data are received, the additional print data and end marker data are temporarily stored to additional print data block 95 and end marker data block 98, respectively (S123). The additional print data and end marker data are not transferred to IP server 70. When a paper cut command (which generally comes last) is detected in the received print data, the paper cut command is also stored in cut command block 97(S123). The saved paper cut command and end marker data are later appended to the second print data sent from IP server 70 (S142, FIG. 15). The divider line print data is added before the additional print data (S124), and printing unit 85 is then instructed to print the divider line print data and additional print data (S125).

Processing the second print data by IP server 70 is described next with reference to FIG. 14. When IP server 70 receives first print data from the interface device 51 (S131), the IP server starts interpreting the first print data, references the advertising or sales promotion information table, and generates second print data related to the products contained in the first print data (S132). When a paper cut command is detected in the first print data, interpreting the first print data ends and the generated second print data is sent to interface device 51 (S133).

Processing the second print data by interface device 51 is described next with reference to FIG. 15. When interface device 51 receives the second print data from IP server 70 (S141), the interface device appends the stored end marker data to the second print data and appends the saved paper cut command after the end marker data (S142). Interface device 51 then sends a print command for this second print data and end marker data, and a paper cut command processing command, to printing process unit 60 (S143).

By adding end marker data and a paper cut command after the second print data in a printer having an automatic paper cutter, the end marker data is printed after the second print data, and receipt 61 is then cut at the trailing end after the end marker data is printed as shown in FIG. 11.

If the printer does not have an automatic paper cutter, the operator can manually tear off the receipt, after seeing that the end marker data has been printed.

Furthermore, when a paper cut command is detected from the first print data in step S125 in FIG. 13, the divider line print data and the additional print data are printed. As a result, the additional print data is printed after the first print data and a divider line is printed between the first print data and additional print data. The boundary between the first print data and other data is thus obvious, and the customer can use this divider line as a cutting line for separating the receipt so that just the coupon, for example, can be given to the operator. Furthermore, because the additional print data can be saved, the store can expect to derive some advertising benefit from the additional print data.

Operation when interface device 51 is set to the non-information-providing mode is described next with reference to FIG. 16. In this embodiment of the invention, additional print data sent from the terminal computer is also not printed when the non-information-providing mode is active. FIG. 16 shows processing the first print data and paper cut command by interface device 51.

When the first print data, additional print data, and end marker data are received from terminal computer 40 (S151), interface device 51 sends a print command with each line of first print data to printing unit 85 (S152). When a paper cut command is received (detected) in the received print data, the paper cut command is temporarily stored (S153) and interface device 51 waits to finish receiving the additional print data and end marker data. When receiving the data is completed, the additional print data is deleted (S154), printing unit 85 is instructed to print the divider line print data and additional print data (S155), and the saved paper cut command is then processed (S156).

Waiting for the second print data is thus obviously not necessary when the non-information-providing mode is set, and a divider line is therefore not printed. As a result, paper and processing time are not consumed by printing a divider line.

As described above, when a paper cut command is detected from the first print data when interface device 51 is set to the information-providing mode in this embodiment, the paper cut command is temporarily stored and divider line data and additional print data are printed. The waiting time from the end of printing the first print data and the start of printing the second print data can thus be used effectively for other printing purposes.

Furthermore, because the paper cut command is temporarily stored and a paper cut command is appended to the second print data, receipt 61 can be printed continuously with the first print data and second print data without a physical break therebetween.

Receipt 61 can also be used as an effective advertising medium because the additional print data can be configured to include such information about upcoming sales, store holidays, and business hours.

Furthermore, additional processes for handling the additional print data are not needed in terminal computer 40, because printer driver 142 can be used to store the additional print data and end marker data in memory. More specifically, by using printer driver 142 to handle additional processes relating to the additional print data, the present invention can be achieved without modifying the POS application.

The end of printing can also be clearly indicated because interface device 51 prints end marker data after the second print data. Therefore, even if there is a pause between printing the first print data and starting to print the second print data, the operator will not mistakenly think that printing has ended when printing the first print data stops.

Furthermore, because end marker data is printed after the first print data when second print data is not sent from IP server 70, the operator thus knows that second print data will not be printed, that is, that printing is over after the first print data is printed.

Yet further, by providing an information-providing mode in which second print data is added and a non-information-providing mode in which second print data is not added (only the first print data is printed) to interface device 51, the desired operating mode can be set at the store's convenience. When a business offers an “early-bird special,” for example, special benefits can be provided to customers that come during the designated service time by, for example, enabling the information-providing mode to print advertising or sales promotion information for discount coupons during the designated hours, and then enabling the non-information-providing mode at other times outside the designated hours.

Saving the paper cut command can also be omitted in this embodiment of the invention. In this case the first print data and other data are printed on separate receipts 61. Note, however, that saving the paper cut command is preferably not omitted when the non-information-providing mode is set. When the non-information-providing mode is set, the paper cut command is preferably saved and then added back after the additional print data (see steps S153 to S156 in FIG. 16). This prevents only the additional print data being separately printed on its own receipt 61 as a result of omitting saving the paper cut command.

Interface device 51 could also be configured to print the additional print data when some other specific data is detected instead of the paper cut command. In this case, the specific data can be set as the end data (the last print data or command contained in the first print data). This arrangement enables detection of this specific data to trigger IP server 70 to output the second print data.

Furthermore, because this specific data is the end data, the specific data will not interfere with IP server 70 interpreting the first print data (i.e., with generating the second print data). Saving the specific data in interface device 51 can be omitted in this arrangement.

The additional print data and end marker data added to the first print data are stored by printer driver 142 in this embodiment of the invention, but the data could be previously stored in interface device 51. By thus enabling the interface device to store and add the additional print data and/or end marker data, the present invention can be achieved without modifying POS application 146 or first print data output unit 142.

Furthermore, adding both the additional print data and end marker data is not always necessary, and only one of these could be used and added as desired. Yet further, one of these could be saved by printer driver 142 and the other by interface device 51.

The divider line print data added after the additional print data in this embodiment is first stored in interface device 51 and added by the interface device as described above. However, the divider line print data could be stored and added by printer driver 142. In this situation, printer driver 142 adds the divider line print data, additional print data, and end marker data after the first print data. In this case, the divider line print data can also be added as part of the additional print data.

Printing the additional print data can also be omitted. More specifically, terminal computer 40 could send the additional print data to interface device 51 only when printing of additional print data print is requested from the interface device 51.

The information-providing mode and non-information-providing mode selection is made using a DIP switch in the foregoing embodiment, but terminal computer 40 could alternatively assert a mode selection (switching) command to set the desired mode.

If a software (logical) switch is used, a logical switch that turns on/off according to the state of a control flag is set in the interface device 51, and the operating mode is determined according to the state of this switch. By thus using a command from the terminal computer 40 to set the operating mode, the mode can be easily changed when, for example, the advertising or sales promotion information is a discount coupon issued only at specific times, such as for a so-called early-bird special (that is, the mode change is time controlled).

Furthermore, when a no_data status signal indicating that second print data is not sent from the IP server 70 is received in the foregoing embodiment, the second print data print command is omitted and only the end marker data is printed and the paper cut command is processed. In this situation, however, a phrase (called the “second end marker data” below) such as “no coupons are available for these products” can be substituted for the end marker data. This second end marker data can also be previously stored in the interface device 51, the printer driver 142 could add the additional print data, end marker data, and second end marker data after the first print data, and the interface device 51 could delete the end marker data or second end marker data according to whether or not the second print data is received.

This arrangement clearly indicates for the customer that no products qualifying for a coupon, for example, were purchased, and the operator knows that printing is completed when either the end marker data or second end marker data is printed.

Furthermore, the address of a website that informs the customer what products qualify can be printed, if no products that qualify for a coupon were purchased, thereby enabling the customer to discover what products qualify and thus encourage the customer to purchase certain products.

The foregoing embodiments of the invention assume that a paper cut command is contained in the first print data generated by the POS application 146. If the POS application 146 does not insert a paper cut command in the first print data, however, the printer driver 142 could be configured to add a paper cut command after the end of the first print data.

As the foregoing demonstrates, a printing system according to the present invention can be used in a POS system. Other configurations/arrangements are also possible. For example, the invention can also be used in a printing system comprising a first host device for generating first print data for each process, a second host device that generates second print data based on interpreting the first print data, and a printer having an expansion port in which an interface device having one or more communication ports for connecting to the first host device and second host device can be installed.

Moreover, the present invention is not limited to a terminal computer 40 (POS application 146) as described above, but can alternatively be implemented in an arrangement in which an information-providing server is connected to a terminal computer, and the terminal computer runs a lookup process similar to the lookup process for searching the master set on the POS server to acquire the advertising or sales promotion information. This can be accomplished by modifying the terminal computer or POS application. More specifically, to implement the present invention in such an arrangement, the functions of interface device 51 in the present invention are handled by printer driver 142, and the first print data output by POS application 146 is sent through that printer driver to IP server 70. Printer driver 142 can then extract transaction numbers, and send the end status data acquired from interface device 51 to IP server 70.

Interface device 51 is also described in the foregoing embodiments as having two communication ports, specifically a host interface 52 to which terminal computer 40 is connected, and an IP server interface 54 to which IP server 70 is connected. The first print data and second print data could, however, be received through a single communication port connected to a hub, for example. In this case, a unique ID is assigned to each host device (terminal computer 40 and/or IP server 70), and this device ID is attached to the print data and sent to interface device 51, thereby enabling the interface device 51 to identify what data was received.

Furthermore, a paper cut command is usually added to the first print data. An alternative method can therefore recognize received data containing a paper cut command to be first print data, and data not containing a paper cut command to be second print data.

An adapter (connection device) having three communication ports (interfaces) for connecting a terminal computer 40, IP server 70, and printer 50 can also be used instead of interface device 51 to execute the functions of the interface device described above.

The functions of interface device 51 described in the foregoing embodiments can also be realized as a computer-executable program, which, when executed, directs an appropriate system (e.g., POS)) to perform a method of controlling the printing system of the present invention as described above.

This program can be carried or stored on any suitable medium, e.g., a CD-ROM, flash ROM, a memory card (compact flash, smart media, or memory stick, for example), CD, magneto-optical disc, DVD, floppy disk, carrier wave, or other computer/device-readable medium.

While the invention has been described in conjunction with specific embodiments, various alternatives, modifications and applications will be apparent to those skilled in the art in light of the foregoing description. Thus, the invention described herein is intended to embrace all such alternatives, modifications and applications as may fall within the spirit and scope of the appended claims.

1. A printing system having a print processing unit, comprising:
a terminal computer comprising
a first print data generating unit configured to generate first print data containing sales information related to a transaction;
an information-providing server that comprises
a second print data generating unit configured to analyze the first print data and determine if any advertising or sales promotion information stored in the information-providing server is relevant to the sales information of the first print data, and to selectively generate second print data containing relevant advertising or sales promotion information based on the analyze and determine operations; and
an interface device in communication with the terminal computer and the information-providing server, the interface device being configured to receive the first print data from the terminal computer, the interface device comprising
a first print data processing unit configured to send the first print data received from the terminal computer to the print processing unit for printing and to the information-providing server for analysis, and
a second print data processing unit configured to send any second print data received from the information-providing server to the print processing unit for printing;
wherein the print processing unit is configured to print a receipt based on the first print data, and also on the second print data if generated.

2. A printing system as described in claim 1, wherein:
the interface device generates and sends end status data denoting receipt of an end identification code to the information-providing server, after the end identification code is received from the terminal computer, the end identification code comprising specific data indicating that transmission of the first print data from the terminal computer to the interface is coming to an end, and
the information-providing server stops analyzing the first print data when the end status data is received, selectively generates the second print data based on the analyze and determine operations, and sends the second print data, if generated, to the interface device.

3. A printing system as described in claim 2, wherein:
the first print data generating unit of the terminal computer sets a different transaction number for each transaction, and generates the first print data for each transaction with the corresponding transaction number contained therein,
the first print data processing unit of the interface device extracts the transaction number from the first print data, and sends the end status data with the transaction number appended thereto to the information-providing server, and
the second print data generating unit of the information-providing server generates the second print data for select advertising or sales promotion information that is determined to be linked to the sales information of the first print data, adds the transaction number to the generated second print data, and sends the generated second print data to the interface device.

4. A printing system as described in claim 2, wherein the end identification code comprises a paper cut command that controls cutting a trailing end of the paper, and the end status data is represented by the paper cut command.

5. A printing system as described in claim 2, wherein the first print data generating unit of the terminal computer sets a different transaction number for each transaction, and generates the first print data with the corresponding transaction number for each transaction contained therein, the printing system further comprising:
a printer driver configured to control the print processing unit, extract the transaction number from the first print data, generate transaction number data, and add the transaction number data to the first print data;
wherein the first print data sent by the interface device to the information-providing server includes the transaction number data added thereto; and
wherein the second print data generating unit of the information-providing server adds the transaction number data to the second print data, if generated, and sends the generated second print data with the transaction number data added thereto to the interface device.

6. A printing system as described in claim 3, wherein the information-providing server further comprises a second print data generation history storage medium that stores a record of second print data generated and links each set of second print data generated to the corresponding transaction number.

7. A printing system as described in claim 4, wherein the interface device interprets the first print data received from the terminal computer, temporarily stores the paper cut command when received, sends the first print data to the print processing unit without sending the paper cut command, and sends the stored paper cut command after the second print data to the print processing unit when the second print data is received from the information-providing server.

8. A printing system as described in claim 4, wherein the interface device interprets the first print data received from the terminal computer and temporarily stores at least the paper cut command without sending the paper cut command to the print processing unit when the paper cut command is received, then generates specific print data, sends the specific print data to the print processing unit, and asserts a print command.

9. A printing system as described in claim 8, wherein the interface device sends divider line print data for printing a divider line widthwise with respect to the receipt as the specific print data to the print processing unit, before asserting the print command.

10. A printing system as described in claim 9, wherein:
the terminal computer stores end marker data as last print data for printing near a trailing end of the receipt, and sends the end marker data after the first print data to the interface device;
the interface device temporarily stores the paper cut command and end marker data without sending either to the print processing unit when the paper cut command is received, and issues a divider line print data print command; and
the second print data processing unit adds the stored end marker data and paper cut command after the second print data when second print data is received, asserts a second print data and end marker data print command, and asserts a paper cut command processing instruction.

11. A printing system as described in claim 10, wherein:
if it is determined by the information-providing server that no advertising or sales promotion information is relevant to the sales information of the first print data, the information-providing server generates and sends to the interface device non-printing status data indicating that second print data has not been generated; and
the second print data processing unit of the interface device omits the second print data print command when non-printing status data is received from the information-providing server, and asserts the end marker data print command and paper cut command processing instruction.

12. A printing system as described in claim 4, wherein:
the interface device further comprises a mode setting unit for setting (i) an information-providing mode for operating both the first print data processing unit and second print data processing unit, or (ii) a non-information-providing mode in which the second print data processing unit is not operated; and
when the non-information-providing mode is set, the first print data processing unit of the interface device omits sending the first print data to the information-providing server, and asserts the paper cut command after the first print data print command without storing the paper cut command when a paper cut command is received.

13. A printing system as described in claim 12, wherein the mode setting unit comprises a DIP switch disposed in the interface device, or a software switch built into the interface device.

14. A printing system as described in claim 1, wherein the interface device is installable in a printing apparatus in which the print processing unit is embodied.

15. A printing system as described in claim 1, wherein the interface device comprises two communication ports, one for connection to the terminal computer and the other for connection to the information-providing server.

16. A POS system comprising the printing system as recited in claim 1,
wherein the terminal computer comprises a plurality of terminal computers, and the interface device comprises a plurality of interface devices, one associated with each terminal computer; and
the POS system comprises a POS server in communication with, and configured to centrally manage, the plurality of terminal computers.

17. An interface device capable of being attached to a printer in a printing system, the interface device comprising:
a first print data processing unit configured to send first print data received from a terminal computer to the printer for printing and to an information-providing server for analysis and consideration in determining whether to generate second print data; and
a second print data processing unit configured to send the second print data received from the information-providing server to the printer.

18. A control method for a printing system that comprises a first host device for generating first print data, a second host device for performing an analysis on the first print data and for selectively generating second print data based on the analysis, and a printer having an interface device for receiving the first print data and second print data and for printing based on the first print data and second print data, the control method comprising:
sending the first print data received by the interface device from the first host device to the printer and asserting a first print command, and also to the second host device;
analyzing the first print data received by the second host device from the interface device, detecting if any advertising or sales promotion information stored in the second host device is relevant to sales information contained in the first print data, and selectively generating the second print data based on the analyzing and detecting operations;
sending any generated second print data to the interface device; and
sending the second print data, if received by the interface device from the second host device, to the printer and asserting a second print command.

19. A printing system control method as recited in claim 18, further comprising:
sending end status data to the second host device in response to receipt by the interface device of an end identification code that is contained in the first print data and indicates that transmission of the first print data from the terminal computer is complete or substantially complete; and
terminating the analyzing and detecting operations being performed on the first print data when the end status data is received by the second host device, and sending the second print data, if generated, to the interface device.

20. A printing system control method as recited in claim 19, further comprising:
temporarily storing the paper cut command when it is detected in the first print data received from the first host device, and sending the first print data but not a paper cut command to the printer;
wherein the step of sending the second print data includes sending the stored paper cut command after the second print data to the printer, if the interface device receives the second print data from the second host device.

21. A printing system control method as described in claim 20, wherein, in the step of storing the paper cut command, the interface device generates specific print data and sends the specific print data to the printer for printing.

22. A medium or waveform containing a set of instructions adapted to cause an instruction-executing device to execute the printing system control method of claim 18.
